(19) United States
(12) Patent Application Publication
(10) Pub. No.: US 2024/0140479 A1
(43) Pub. Date: May 2, 2024

(54) Automation in Inclement Weather

(71) Applicant: Board of Trustees of Western Michigan University, Kalamazoo, MI (US)

(72) Inventors: Zachary David Asher, Kalamazoo, MI (US); Nicholas Alan Goberville, Mokena, IL (US); Parth Kadav, Kalamazoo, MI (US)

(21) Appl. No.: 18/494,839

(22) Filed: Oct. 26, 2023

Related U.S. Application Data
(60) Provisional application No. 63/419,844, filed on Oct. 27, 2022.

(51) Int. Cl. B60W 60/00; B60W 40/02

(52) U.S. Cl. CPC B60W 60/001; B60W 40/02; B60W 2552/53; B60W 2555/20; B60W 2556/20; B60W 2556/35

(57) ABSTRACT

An adverse weather operations system includes one or more sensors and a computing device that processes sensor data to assist a vehicle in planning a vehicle path. Weather metrics can be utilized to determine a perception model having the most accurate results for the conditions being encountered by the vehicle.

### CROSS REFERENCE TO RELATED APPLICATIONS

The present application claims the benefit under 35 USC § 119(e) to U.S. Provisional Patent Application No. 63/419,844, filed Oct. 27, 2022; the entire disclosure of that application is incorporated herein by reference.

### BACKGROUND

Efforts have been made to include advanced driver assistance systems (ADAS) in automotive passenger vehicles.

A hurdle for implementation of automation systems in vehicles involves the limitations of known operational design domain (ODD). Some existing ADAS technologies may only be operational during ideal conditions, i.e., highway driving in clear weather.

### SUMMARY

In order to improve automation, the current ODD of ADAS features may be expanded to include more diverse scenarios, including adverse weather conditions. Adverse weather design domain definitions are numerous since they can include various levels of fog, rain, snow, and more. Each of these may be quantified at the vehicle-level to comply with existing ADAS computer vision techniques which may be based on supervised machine learning (ML) or deep neural network (DNN) models trained with data from clear weather conditions, resulting in a weather-biased model. Data gathered during all weather conditions may be included in datasets used to train ML or DNN perception models. However, there are also major challenges in trying to include too many scenarios in ML/DNN training, as this may cause under-fitting. A solution for this is to implement hierarchical decision making to switch between models trained for operation in specific weather conditions. This hierarchical decision making for perception may be implemented by providing the automated system with a better understanding of the real time weather conditions. This is possible for snow covered road conditions through the use of the ADAS perception system sensors.

### BRIEF DESCRIPTION OF THE DRAWINGS

In the drawings:

FIG. 1 is a schematic view of a vehicle that may be configured to utilize a driver assistance system according to an aspect of the present disclosure;

FIG. 2 is an overall systems-level diagram of a hierarchical structure showing an aspect of a driver assistance system;

FIG. 3 is a systems overview of a general vehicle automation system;

FIG. 4 is a flowchart outlining a process for collecting and preparing camera images;

FIG. 5 comprises graphs and example images from snow-coverage classification categories with their corresponding RGB pixel histograms;

FIG. 6 is a graph showing precipitation rates from Jan. 16, 2021 to Feb. 20, 2021 gathered from a land weather station;

FIG. 7 is a general description of pixel-level, image-level, and video-level analysis including an example with images;

FIG. 8 is a flow diagram of a process for extracting Region of Interest (ROI) histograms from each image in a time-series video;

FIG. 9 is a flow diagram outlining a process of exploiting video-level feature descriptions used for an analysis according to an aspect of the present disclosure;

FIG. 10 comprises pie charts showing confidence of the left and right lane line detections from an existing computer vision system for the drive cycles of Table 2, wherein NONE refers to no confidence in the detection, LOW is low confidence, MED is medium confidence, and HIGH is high confidence;

FIG. 11 comprises charts showing distribution of RGB color channel mean values for various snow coverage conditions;

FIG. 12 is a graph showing video-level average color channel values grouped into snow coverage labels;

FIG. 13 is a graph showing daily precipitation metrics plotted with the daily average RGB values gathered from the images;

FIG. 14 is a correlation heat map between RGB color channels and the weather metrics;

FIG. 15 is a methodology pipeline used for data preparation and model development;

FIG. 16 is a flow diagram of tasks completed for data preparation;

FIG. 17 is a flow diagram for data collection, resampling of the data from 30 Hz to 5 Hz, selecting 1,500 images from the dataset, and labeling of the data;

FIG. 18 shows an example usage of CVAT for annotating tire tracks with polygons (left) and the output mask of the labeling process (right);

FIG. 19 shows a process that may be used for feature extraction, beginning with extracting only the frames within the region of interest, and then extracting the features from those pixel values;

FIG. 20 is a flow diagram for ML model training wherein an input array contains features extracted from raw images, and a label vector y contains the pixel status as either tire track (1) or not tire track (0);

FIG. 21 is a chart showing the difference from the mean mIoU of all trained models trained with each feature set;

FIG. 22 is a chart showing the operating frame rate of the models tested on an 8^{th} Gen Intel i7 processor;

FIG. 23 is a flow diagram for data collection, resampling of the data, extracting RGB Images and corresponding Tire Track Labels, and labeling of data;

FIG. 24 illustrates the feature extraction procedure, which begins by extracting only the frames within the ROI and then extracts the features from those pixels;

FIG. 25 is a flow diagram for training a Machine Learning (ML) model, wherein the features recovered from the raw photos are stored in the input feature array X, and the label vector y contains the pixel status as either tire track (1) or non-tire track (0);

FIG. 26 is a U-network architecture (example for 32×32 pixels in the lowest resolution), wherein a multi-channel feature map is represented by each box, the number of channels is indicated on the box's top, the x-y size is indicated at the box's lower-left edge, white boxes represent feature maps that have been copied, and the arrows represent the various operations;

FIG. 27 is CNN output, wherein a raw image is on the left, a labeled segmentation mask is in the middle, and a predicted segmentation mask from the CNN is on the right;

FIG. 28 is a graph showing Jaccard loss function with a Jaccard index (IoU) as the metric;

FIG. 29 is a graph showing Binary Cross Entropy (BCE) loss function, with Jaccard Index (IoU) as the metric; and

FIG. 30 is a chart showing Precision, Accuracy, Recall and F1 score metric comparison between CNN and Dtress.

### DETAILED DESCRIPTION OF EMBODIMENTS

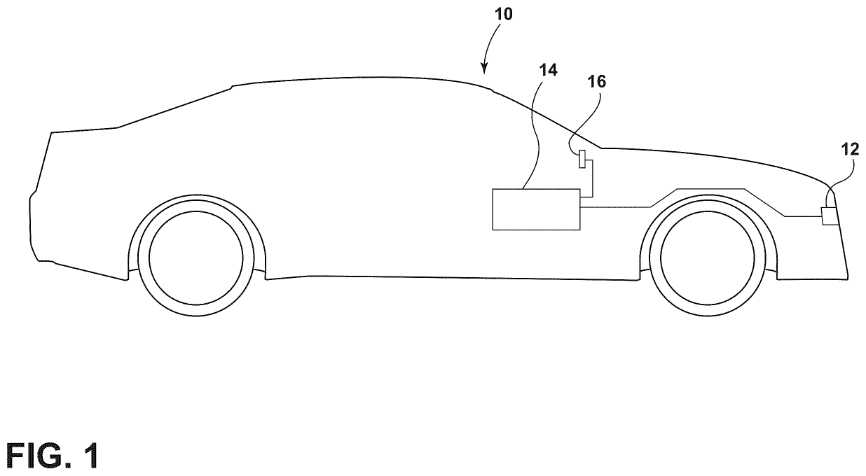

For purposes of description herein the terms “upper,” “lower,” “right,” “left,” “rear,” “front,” “vertical,” “horizontal,” and derivatives thereof shall relate to the disclosure as oriented in FIG. 1. However, it is to be understood that the invention may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

Additionally, unless otherwise specified, it is to be understood that discussion of a particular feature or component extending in or along a given direction or the like does not mean that the feature or component follows a straight line or axis in such a direction or that it only extends in such direction or on such a plane without other directional components or deviations, unless otherwise specified.

Referring to the embodiment illustrated in FIG. 1, reference numeral 10 generally designates a vehicle that may be configured to utilize a driver's assistance process and system according to various aspects of the present disclosure. Vehicle 10 may include one or more sensors 12 that are operably connected to a control system 14. The sensor 12 may comprise, for example, one or more cameras that face in a forward direction to provide images to the control system 14 that can be utilized to assist a driver of the vehicle. Control system 14 may comprise one or more controllers, data networks, a GPS module, communications modules (e.g. cellular), vehicle speed sensor, acceleration sensors, ambient condition sensors (e.g. temperature sensors), steering sensors, vehicle pitch, roll, and yaw position/velocity/acceleration sensors, braking system sensors, etc. The control system 14 may be configured to receive information concerning inclement weather conditions such as precipitation (rain or snow), and other local road conditions from a remote source (not shown) via a communication module of a type (e.g. cellular) that is generally known.

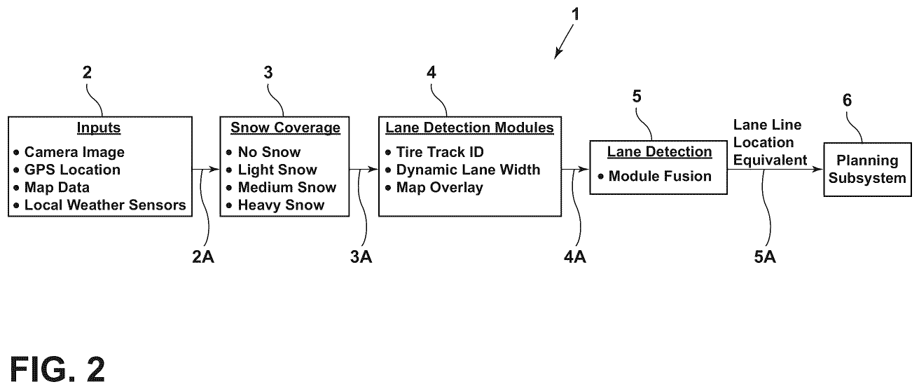

Vehicle 10 may be configured to implement the system 1 of FIG. 2. The system 1 utilizes inputs 2 such as one or more camera images, GPS location, map data, and local weather sensors. It will be understood that the system 1 does not necessarily require all inputs 2 shown in FIG. 2. Alternatively, the system 1 may utilize additional inputs in addition to the inputs of FIG. 2.

The input data 2A is provided to a snow coverage detection module 3. As discussed in more detail below, the snow coverage detection module (e.g. software) may be configured to determine if the road immediately in front of vehicle 10 has no snow, light snow, medium snow, or heavy snow. It will be understood that these terms do not necessarily need to be utilized. For example, the snow coverage conditions could be given a numerical value of 1-10 in which 1 represents no snow, and 10 represents a maximum amount of snow.

After the snow coverage is determined by snow coverage module 3, the snow coverage information 3A is transferred to one or more lane detection modules 4. As discussed in more detail below, the lane detection modules (e.g. software) may include a module that detects (identifies) tire tracks in front of vehicle 10, a module that determines (e.g. dynamically) a width of a lane directly in front of a vehicle, and a map overlay module. The lane detection modules 4 may further include one or more existing (i.e. known) lane detection modules. The lane detection module 5 generates a lane line location equivalent 5A that is provided to a planning subsystem 6. The planning subsystem 6 may comprise a component of control system 14 (FIG. 1), and may provide an operator of vehicle 10 with driving assistance such as information provided on a display screen 16 (FIG. 1). The planning subsystem 6 may also be configured to cause control system 14 to provide driver assistance in the form of steering control, braking control, engine acceleration control, etc.

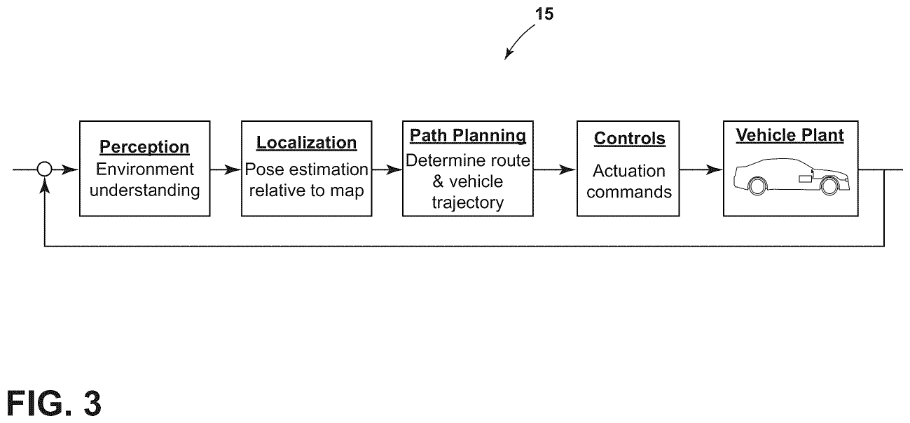

With further reference to FIG. 3, control system 14 may be configured to implement a vehicle automation system 15. The perception system of an automated driving stack (FIG. 3) may be utilized to construct a real-time map of a vehicle's operating environment. This map may include objects (vehicles, pedestrians, bicycles, etc.), the drivable region (road surface boundary, lane width, etc.), the route state (speed limit, traffic lights, etc.), and more. In order to build this map, features may be extracted from sensor data such as camera images, radar detections, and LiDAR 3D point clouds using ML, DNNs, or statistical modelling.

Another aspect of the present disclosure comprises a custom dataset that may be gathered from a test vehicle such as the EEAV (Energy Efficient and Autonomous Vehicles) lab's research vehicle platform, which may include camera images and lane line detection devices and/or software. Precipitation data was acquired from local weather stations. This data was analyzed using statistical comparisons and then used to develop machine learning (ML) models for estimating the snow coverage on the road. This may be utilized to estimate snow coverage on a road using image features combined with precipitation data from local weather stations.

The present disclosure further includes forming a dataset using snowy weather images and lane detections, conducting statistical analyses on the image data & precipitation data, and one or more models for snow overage estimation.

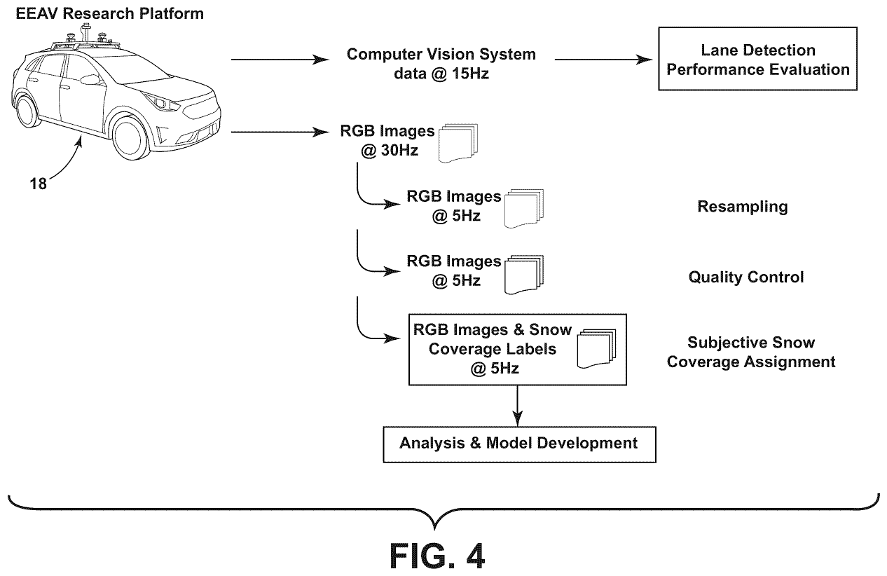

One or more datasets may be utilized to conduct statistical analysis or to train Machine Learning (ML) models for estimating snow coverage using images. An example of an openly available driving dataset that contains data in snow is the Canadian Adverse Driving Conditions Dataset. However, this dataset may not be suitable for some purposes. Thus, another aspect of the present disclosure comprises developing a custom dataset using a research vehicle 18 (FIG. 4) (EEAV research platform) during a winter season in a geographic region (Kalamazoo, Michigan) having significant snowfall. The following discussion identifies the vehicle platform & sensors, route definition, data quality control, and data labeling that was utilized to build this dataset. FIG. 4 depicts this pipeline and each step is defined more in the following subsections.

Vehicle 18 (FIG. 4) is a modified production vehicle and includes a ZED 2 stereo camera, a Mobileye 630 (a commercially available computer vision system), an Ouster LiDAR, a Delphi ESR radar, a FLIR thermal imaging camera, and two Swift Navigation Duro GPS antennas. For purposes of developing the dataset, only data from the Mobileye 630 (“first camera”) and ZED 2 stereo camera (“second camera”) were collected. The (“first camera”) was operated at 15 fps and provided state-of-the-art lane line detections used to determine the performance of lane detection in snow. The (“second camera”) was operated at 30 fps and provided raw RGB camera images used to build the dataset of snow-covered road images. It will be understood that virtually any suitable camera systems may be utilized in accordance with the present disclosure, and the (“first camera”) and (“second camera”) are merely examples of suitable cameras/systems.

A predefined route consisting of 5 different road sections, was chosen to be driven for data collection. Each road section was selected based on having low traffic, two lanes, and clear, visible lane lines. The heading direction was also varied to get a variety of sun angles. All of the road sections are about 1 mile in length.

Multiple weeks of data collection resulted in over 1,500,000 frames of RGB images and (“first camera”) lane detections recorded. The quantity of data was reduced after the videos and (“first camera”) detections were resampled from 30 Hz and 15 Hz, respectively, to 5 Hz. The resampling was done to reduce the quantity of similar images used in analysis and to minimize overfitting during ML training. During the resampling process, the lane detection and zed camera image timestamps were synchronized to match the data with a common timestamp. This resampling and data synchronization was followed by additional quality control assessments designed to eliminate extraneous variables (i.e., over-exposed images from glare, windshield wiper occlusion, poor resolution images from active precipitation, etc.), whereby the dataset comprised 21,375 images spanning 25 road/video segments.

A subjective method may be used to place data from each road segment into one of three snow coverage categories: None, Standard (Light-Medium), or Heavy. Each of the 25 video segments were assigned into one of these categories. Depending on how much snow was covering the surface of the road during the entire video segment, all images within the video were labeled with the respective category. To streamline this labelling process, a graphical user interface (GUI) was developed using PyQT to visualize each image and store the respective labels into a CSV file for use in the analysis. It will be understood however, that virtually any suitable process may be utilized to categorize the images.

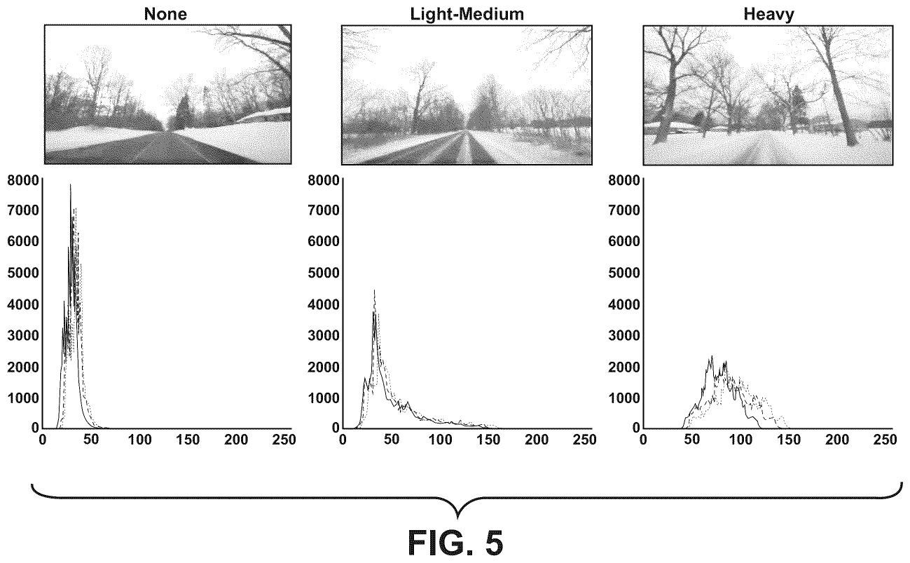

The method of labelling by road section was done as the road sections showed consistent snow coverage throughout all the data. This provides a high-level label per video segment of which all images belonging to that video segment were subsequently inferred to have the same label as the parent video. FIG. 5 shows examples of images placed into each one of the three categories along with associated RGB histograms. These histogram features may be used for data analysis in the varying conditions and for snow estimation model development.

The snow coverage labels were verified to be statistically significant by conducting a one-way Analysis of Variance (ANOVA) to determine the p-value for the relationship between the image-level RGB channel values and the snow coverage categories. As shown in Table 1, ANOVA may provide insight with regards to determining whether or not statistical significance exists between the mean channel values and the groups of snow coverage that were determined for the labels.

TABLE 1
ANOVA calculations which determine statistical significance
between different levels of snow coverage.
The One-Way ANOVA Table (using shortcut formulas)

| [symbol] | [symbol] | [symbol] | [symbol] | [symbol] |
|---|---|---|---|---|
| [symbol] | SSTr [symbol] Σ [symbol] − N [symbol] | k-1 | MSTr [symbol] SSTr/(k-1) | F [symbol] MSTr [symbol] MSE |
| treatment | | | | |
| (Within | SSE − SST [symbol] [symbol] SSTr | N-k | MSE [symbol] SSE [symbol] (N-k) | |
| Group) or | | | | |
| Error | | | | |
| Total | SSTo [symbol] Σx² − N [symbol] | N-1 | | |

[symbol]

indicates data missing or illegible when filed

This significance indicates that there is variability in RGB values versus different levels of snow coverage. This correlation is preferably present to provide for accurate machine learning and/or development of statistical models for predicting snow coverage based on one or both of the mean and variance of RGB values.

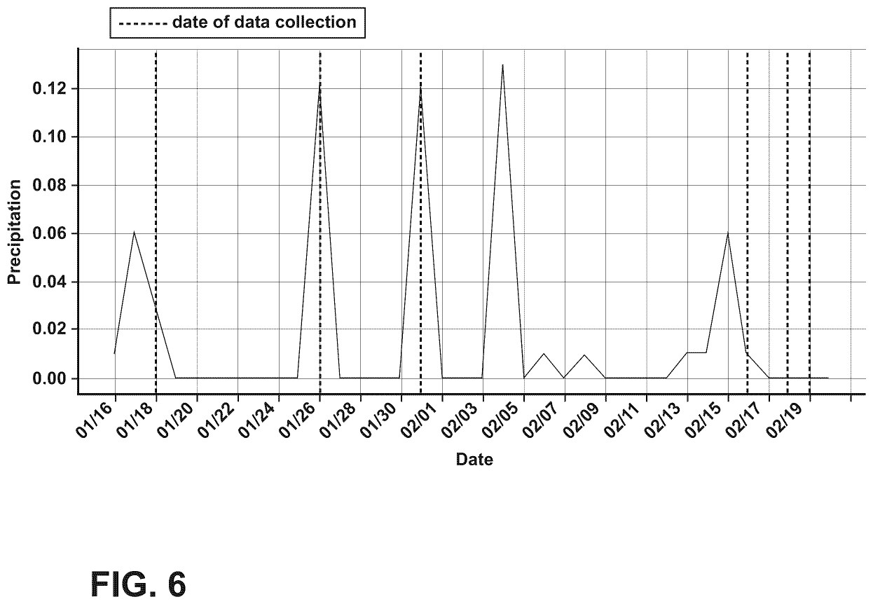

Upon concluding the labelling process, two levels of labels were harnessed for the purposes of the present disclosure: videolevel and image-level. The video-level labels were manually given using the GUI tool discussed above, and the image-level labels were inferred for each image, as mentioned. The weather data (FIG. 6) was gathered from the National Center for Environmental Information (NCEI) database. The data came from the Kalamazoo/Battle Creek International Airport weather station, located approximately 7 miles from the data collection location. This station records daily summaries of precipitation data in the Global Surface Summary of the Day Data (GSOD) format. This daily precipitation metric is given as the Snow Water Equivalent (SWE) in inches. SWE may be used as a reading of snowfall since snow depth can vary greatly throughout a day due to settling and compaction, however, the amount of water contained in the snow remains the same. SWE may be calculated using a snow-to-liquid ratio of 10 inches of snow to 1 inch of water.

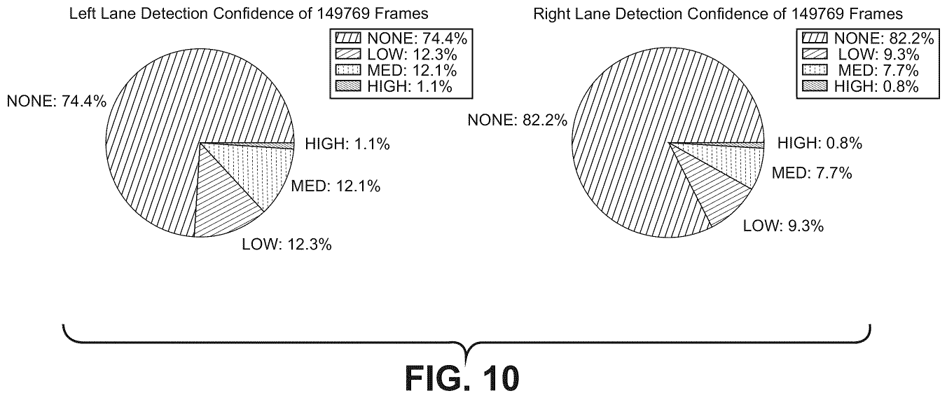

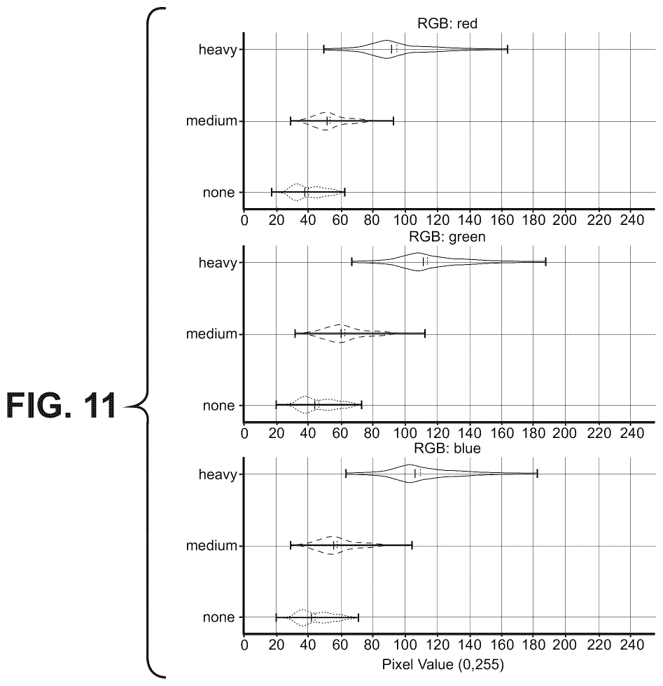

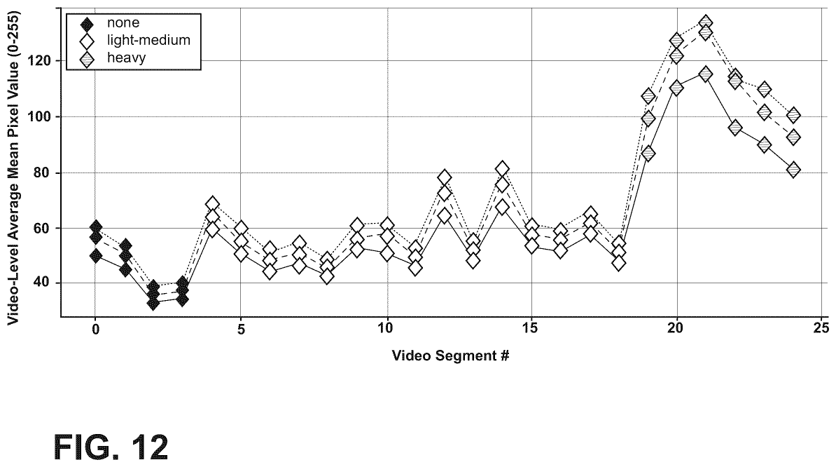

The dataset that was collected and used contains Mobileye (“first camera”) lane detections, images organized into road segment videos, daily SWE values, and snow coverage labels per video segment. In order to use these data sources for estimating snow coverage, the features used for images and parameters used for daily SWE values may be defined. The (“first camera”) data was used to evaluate the performance of existing lane line detection (seen in FIG. 10) in scenarios of snow coverage. This data was not sued in the model development described herein because it did not require any further feature extraction.

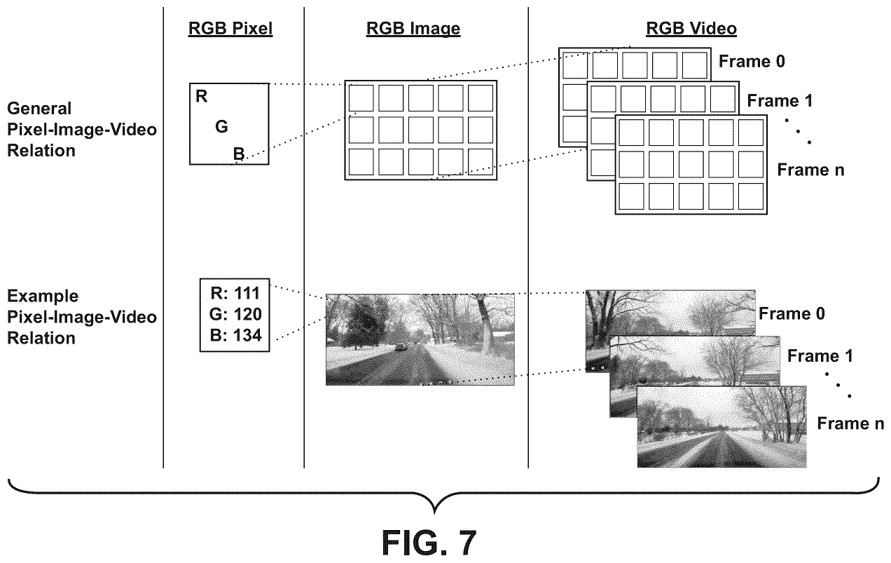

When compared to image frame rates (0.033-0.067 seconds per frame) and the video length in seconds per 1 mile road section (approximately 1.5 minute average), snow surface accumulation changes on a much lower frequency when snowfall is not currently present and the temperature remains below freezing. With minimal fluctuations in surface temperature or snowfall, snow coverage on a road surface can remain consistent for a significant period of time (e.g. several hours). When estimating the coverage of snow on a roads surface, this information can remain true as long as the snow on the road remains consistent. Because of this, two different snow coverage estimation models were developed for this study. One model estimates snow coverage given features from a single image (image-level estimation) to accommodate higher snow coverage variability. The other model utilizes video-level features for snow coverage estimation to accommodate lower snow coverage variability. Differences in pixel-level, image-level, and video-level analysis are shown in FIG. 7.

Images may be a significant source of information, and may include pixel-level color channel values as well as spatial information since these pixel values may be organized into a 3-dimensional array. Various image feature extraction methods exist for computer vision applications. However, this study focuses on RGB histograms as this has been shown to be used for accurate classification modelling.

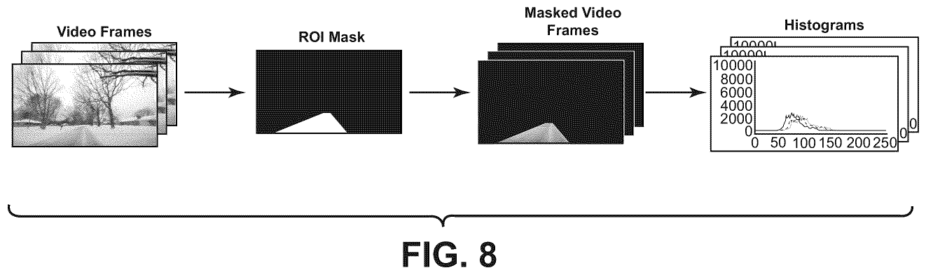

The road surface is the focus for image feature extraction, so the background of the images are preferably eliminated. To eliminate these background pixels, a static Region Of Interest (ROI) may be used. FIG. 8 is a flow diagram showing extraction of the histograms for each image. These histograms show the distribution of pixel values contained within the road surface which may be used for extracting image descriptive features.

In order to conduct image-to-image comparisons, the histograms for each color channel may be converted to a normal distribution by calculating the mean (Eq. 1) and standard deviation (Eq. 2) of the pixel values.

$$\begin{matrix}μ = \frac{1}{N} {\sum }_{i = 1}^{N} {x}_{i} & ( 1 ) \\ SD = \sqrt{\frac{1}{N} {\sum }_{i = 1}^{N} {( {x}_{i} - μ )}^{2}} & ( 2 )\end{matrix}$$

Where N is the total number of pixels in the ROI and xi is each pixel value in the histogram.

These mean and standard deviation (SD) values may be utilized to compare different snow coverage conditions as well as the main computer vision feature input to one or more ML models to estimate these conditions for image-level analysis.

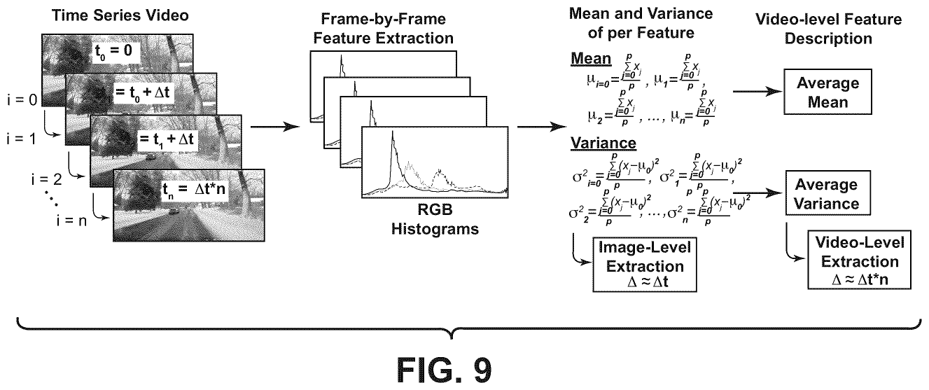

With reference to FIG. 9, the video-level features may be calculated by averaging the image-level means and SDs of all images collected during a video segment. As an example, for a video segment containing 200 images, the mean and SD for each image was averaged using Eq. 1 to provide a single value for the average video mean and the average video SD. These two average values may comprise the features for video-level analysis and modelling.

Accumulation of snow of the road surface may be accounted for by including additional parameters calculated based on daily SWE measurements (e.g. FIG. 6). A correlation of these different parameters versus the snow coverage labels may be utilized to determine which parameter best fits the snow coverage conditions.

As previously mentioned, an aspect of the present disclosure is the development of two different models to estimate the snow coverage on an image-level and on a video-level. Four different feature sets were used as inputs for training of both the image-level estimator and the video-level estimator. These feature sets are shown with the corresponding array shape for training in Table 2.

TABLE 2
Four different feature sets used for each model training.

| | | |
|---|---|---|
| Included | Train Array | Test Aray |
| Features | Shape | Shape |

Image-Level Estimation Feature Sets

| | | |
|---|---|---|
| rgh-mean | (17 [symbol] 099 [symbol] 3) | (4275 [symbol] 3) |
| rgh-mean | (17 [symbol] 099 [symbol] 4) | (4 [symbol] 275 [symbol] 4) |
| SWE precip | | |
| rgb-mean | (17 [symbol] 9999 [symbol] 6) | (4 [symbol] 275 [symbol] 6) |
| rgb-SD | | |
| rgb-mean | (17 [symbol] 099 [symbol] 7) | (4 [symbol] 275 [symbol] 7) |
| rgb-SD | | |
| SWE precip | | |

Video-Level Estimation Feature Sets

| | | |
|---|---|---|
| rgb-mean | (20 [symbol] 3) | (5 [symbol] 3) |
| rgb-mean | (20 [symbol] 4) | (5 [symbol] 4) |
| SWE precip | | |
| rgb-mean | (20 [symbol] 6) | (5 [symbol] 6) |
| rgb-SD | | |
| rgb-mean | (20 [symbol] 7) | (5 [symbol] 7) |
| rgb-SD | | |
| SWE precip | | |

[symbol]

indicates data missing or illegible when filed

The snow coverage labels previously indicated as none, standard, and heavy may be mapped to a unique integer for purposes of training one or more ML models for estimating the snow coverage condition. These three integer values may be 0, 1, and 2, for none, standard, and heavy snow coverage, respectively. This mapping may provide the representation of each snow coverage category in an ML training process.

In an example according to an aspect of the present disclosure, six different ML algorithms were used to determine the algorithm/feature set pair with the greatest performance metrics. The ML algorithms (models) evaluated were K-Nearest Neighbor (KNN), Naive-Bayes, Decision Trees, Random Forest, Logistic Regression, and Support Vector Machines (SVM). These ML algorithms were selected based on their expected capabilities with regards to computing classification for computer vision applications.

To evaluate the models, the predicted outputs of the models may be compared with the ground truth for evaluation using a test set. The metrics were evaluated based, at least in part, on the ability to draw significant conclusions concerning the model performance. The model accuracy may be used for the main model evaluation. Eq. 3 shows how accuracy may be calculated using the number of accuracy classifications vs inaccurate classifications where CP is the number of correct predictions and TP is the number of total predictions.

$$accuracy = \frac{CP}{TP} \qquad ( 3 )$$

The results discussed herein provide an overview of the dataset collected including the performance of the (“first camera”) lane detections, the analyses conducted for image level, video-level, and weather data, and the results of ML training for snow coverage estimation.

The quantity of video segments and images as well as the various dates and routes travelled is summarized in Table 3.

TABLE 3
Overview of the dataset collected consisting of RGB images. The
road sections were assigned a letter per road section driven on.

| | Road Sections | | |
|---|---|---|---|
| | Included (see | | |
| Date | FIG. 3) | Road Segments | Total Images |
| Jan. 18, 2021 | A, B* | 2 | 1385 |
| Jan. 26, 2021 | A, B, C, D, E | 6 | 5474 |
| Jan. 31, 2021 | A, B, C, D, E | 6 | 5478 |
| Feb. 16, 2021 | A, B, C* | 3 | 2828 |
| Feb. 18, 2023 | A, B, C, D, E | 5 | 3730 |
| Feb. 19, 2021 | C, D, E* | 3 | 2480 |

| | | |
|---|---|---|
| Total | 25 | 21375 |

*Data from remaining road sections removed per quality control.

Along with the data collected for the image-level, video-level, and weather analysis, the (“first camera”) lane detection data was collected to show the performance of existing lane detection in snowy conditions. In these systems, the confidence of detections is preferably high. With reference to FIG. 10, from the model tested, only 1.1% and 0.8% of the lane detections were high confidence for the left lane and right lane, respectively. For both left and right lanes, the model outputs detections with zero confidence are 74.4% and 82.2% of the adverse weather drive cycles, respectively. Zero confidence indicates the model has substantially no understanding of where potential lane lines are located.

A distribution analysis of RGB values in the subjective snow coverage conditions described above is shown in FIG. 10. As shown in FIG. 10, the distribution of the mean RGB values shows a correlation with the 3 different levels of snow coverage. All 3 color channels follow a similar distribution in which the mean pixel value for none, light-medium, and heavy snow continuously increases from none to heavy. Red pixel values saw a 32.62% and 79.48% increase in mean pixel value from none to light-medium and light-medium to heavy snow coverages, respectively. Green saw a 32.09% and 83.56% increase of these same differences, and blue saw a 29.45% and 89.82% increase.

The ANOVA results show that there may be a strong statistical significance between

the color channel mean values and the snow coverage category. Each ANOVA result yielded a high F value and a Pr(>F) (p-value) of 0.0, indicating a strong correlation.

TABLE 4
ANOVA output showing strong statistical significance
of snow coverage vs color channel pixel values

| | | | | | |
|---|---|---|---|---|---|
| | | Degrees | | | |
| | Sum of | of | Mean | | |
| Source | Squares | Freedom | Squares | F Value | p-value |

red channel vs snow coverage

| | | | | | |
|---|---|---|---|---|---|
| Between | 8.57 × 10⁶ | 2 | 4.29 × 10⁶ | 25721.36 | 0.00 |
| Within | 3.56 × 10⁶ | 21371 | 1.67 × 10² | — | — |
| Total | 1.21 × 10⁷ | 21373 | — | — | — |

green channel vs snow coverage

| | | | | | |
|---|---|---|---|---|---|
| Between | 1.28 × 10⁷ | 2 | 6.41 × 10⁶ | 29467.74 | 0.00 |
| Within | 4.65 × 10⁶ | 21371 | 2.17 × 10² | — | — |
| Total | 1.75 × 10⁷ | 21373 | — | — | — |

blue channel vs snow coverage

| | | | | | |
|---|---|---|---|---|---|
| Between | 1.25 × 10⁷ | 2 | 6.26 × 10⁶ | 31515.44 | 0.00 |
| Within | 4.24 × 10⁶ | 21371 | 1.98 × 10² | — | — |
| Total | 1.68 × 10⁷ | 21373 | — | — | — |

The average pixel values are generally higher for each increase in snow coverage. Similar to the image-level results, there is a continuous increase from no snow to heavy snow coverage. The “none” snow coverage category has average values of 40.59, 47.64, 45.241 for red, green, and blue, respectively. “Light-medium” snow coverage has average values of 52.08, 60.64, 56.44, and heavy coverage has average values of 96.59, 115.38, 110.54 for red, green, and blue respectively. In this example, for each color channel, there is an increase in value moving from “none” to “light-medium” to “heavy” snow coverage. This demonstrates the capability of utilizing the video-level averages to develop a method of estimating snow coverage utilizing video data.

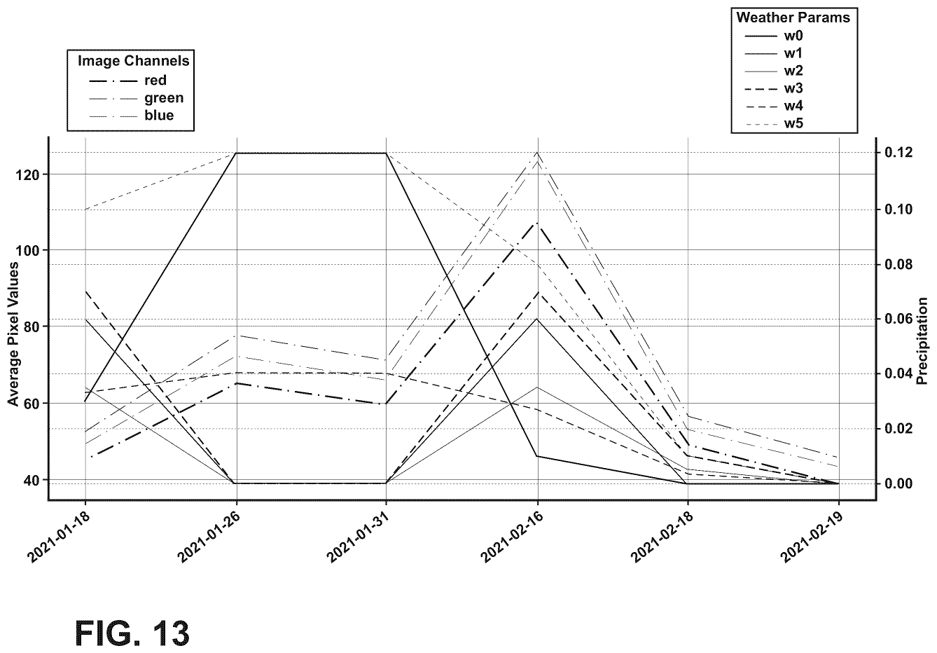

The weather data parameters are summarized in FIG. 13. With regards to the correlation of the RGB values and the weather parameters, w₄ correlates quite well for most days except for one day (2021 Jan. 16). This is approximately the same result for w₀ & w₅.

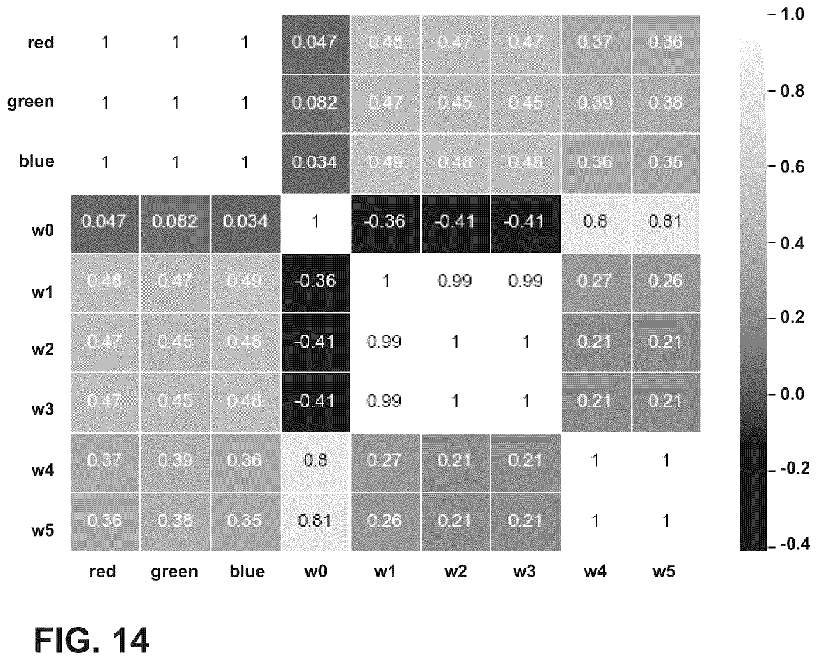

Given the variability in these metrics, a heat map of the correlation with RGB color channels vs weather parameters is shown in FIG. 14 to show these correlations. From this heat map, the highest correlation is between w₁, w₂, & w₃. This may be expected because these 3 parameters include the precipitation of the previous day. Because most data collection was done early in the morning, the previous day's precipitation may be expected to have the most impact on snow coverage on the road.

Of the models evaluated herein, the Random Forest algorithm yields the overall best results for predicting both image-level and video-level snow coverage estimations. The results from all models trained with various ML algorithms are shown in Tables 6 and 7.

TABLE 6
Model results for image-level snow estimation (no. train samples = 17,099, no. test samples = 4,275).

| | [symbol] | | [symbol] | | [symbol] | | [symbol] | | KNN | | Logistic | |
|---|---|---|---|---|---|---|---|---|---|---|---|---|
| [symbol] | acc | acc-max | acc | acc-max | acc | acc-max | acc | acc-max | acc | acc-max | acc | acc-max |
| rgb-mean | 0.8793 | −0.0241 | 0.8760 | −0.0641 | 0.9122 | −1.0422 | 0.789 [symbol] | −0.0381 | 0.9127 | −0.0 [symbol] | 0.8414 | −0.0 [symbol] |
| rgb-mean & precip | 0.8763 | −0.0273 | 0.8926 | −0.0475 | 0.92 [symbol] | −0.033 [symbol] | 0.8168 | −0.6163 | 0.9120 | −0.0 [symbol] | 0. [symbol] 2707 | −1.023 [symbol] |
| rgb-mean & rgb-std | 0.8096 | −0.0040 | 0.9256 | −0.0145 | 0.9485 | −0.007 [symbol] | 0. [symbol] 084 | −0.6187 | 0.0596 | −0.0010 | 0.8508 | 0.0 [symbol] |
| rgb-mean, rgb- | [symbol] | 0.0 [symbol] | 0.9401 | 0.0 [symbol] | 0.9563 | [symbol] | 0.8271 | 0.0000 | 0. [symbol] | 0.000 | 0.8501 | −0.0007 |
| std, & precip | | | | | | | | | | | | |
| max (best | 0.9 [symbol] 36 | | 0.9401 | | 0.9563 | | 0.8271 | | 0.9536 | | 0.8508 | |
| performing model) | | | | | | | | | | | | |

[symbol]

indicates data missing or illegible when filed

TABLE 7
Model results for video-level snow estimation (no. train samples = 20; no. test samples = 5).

| | [symbol] | | [symbol] | | [symbol] | | [symbol] | | KNN | | Logistic | |
|---|---|---|---|---|---|---|---|---|---|---|---|---|
| [symbol] | acc | acc-max | acc | acc-max | acc | acc-max | acc | acc-max | acc | acc-max | acc | acc-max |
| rgb-mean | 0.8 | 0.0 | 0.8 | −0.7 | 1.0 | 0.0 | 0. [symbol] | −0.2 | 0.8 | 0.0 | 1.0 | 0.0 |
| rgb-mean & precip | 0.8 | 0.0 | 1.0 | 0.0 | 1.0 | 0.0 | 1.0 | 0.0 | 0.6 | −.02 | 1.0 | 0.0 |
| rgb-mean & rgb-std | 0.8 | 0.0 | 0. [symbol] | −0.4 | 0.8 | −0.2 | 1.0 | 0.0 | 0. [symbol] | −0.2 | 1.0 | 0.0 |
| rgb-mean, rgb- | 0.8 | 0.0 | 0. [symbol] | −0.4 | 0.8 | −0.2 | 0. [symbol] | −0.4 | 0.8 | 0.0 | 0.0 | −0.4 |
| std, & precip | | | | | | | | | | | | |
| max (best | 0.8 | | 1.0 | | 1.0 | | 1.0 | | 0.8 | | 1.0 | |
| performing model) | | | | | | | | | | | | |

[symbol]

indicates data missing or illegible when filed

The models were trained using two sets of image predictors: RGB mean values
1. RGB mean values
2. RGB mean and standard deviation values

From the results in Table 6, the image-level models performed better with mean and standard deviation as predictors (models 1a and 1b in Table 5), but the video-level models (Table 7) performed better with only the mean RGB values as predictors (models 2a and 2b in Table 5). For weather predictors, previous day precipitation was used herein because this parameter had the highest correlation with RGB values, observed in FIG. 14.

In general, the image-level coverage estimation models disclosed herein provide very good (accurate) results. The accuracy of the purely image-based model (model 1a) yields accurate results without the use of weather predictors. With the inclusion of weather predictors, the accuracy of the model is further increased. Though this increase is about 1%, this is an indication that past weather information can play a role in developing these predictions.

By observing statistical significance between camera data, snow coverage conditions, and weather parameters (w₁, w₂, & w₃), ML models were developed to provide estimations of snow coverage utilizing the observed correlations and relational significance. It is possible to determine how the temporal resolution of precipitation data affects the predictions differently by splitting the analysis and model development into image-level estimation and video-level road segment estimation. For image-level estimation, the inclusion of precipitation data increased the model's accuracy by about 1%. Using higher temporal weather data may provide even more accurate results for snow coverage estimation for the image-level models. The video-level estimation saw 100% testing accuracy for the level of snow coverage with and without weather predictors. Because the model was able to predict all test sets 100% correctly, there is an indication that scaling up the data collection and model verification methodology could provide significant insights with regards to achieving robust road segment snow coverage.

The results disclosed herein show a clear correlation between RGB color channels and the snow coverage on the surface of the road. However, more detailed image features for snow coverage estimation may also be utilized. Principal component analysis may be used to determine the most significant image features for accurate snow coverage estimation. Higher temporal and more localized weather data may also be utilized to improve snow coverage estimates.

As discussed above, the present disclosure demonstrates a statistical significance of raw RGB camera data and snow coverage conditions, and also shows a correlation between precipitation data and the camera data. As discussed above, the present disclosure further includes an image-by-image snow coverage estimation model, and a road segment snow coverage estimation model. The image-by-image model may be utilized in numerous situations, including vehicles driving on unmapped roads, and to understand the weather locally without access to HD maps. The road-segment model may be utilized for updating HD maps in real-time, providing other vehicles with the snow coverage on a roads surface prior to driving down that road.

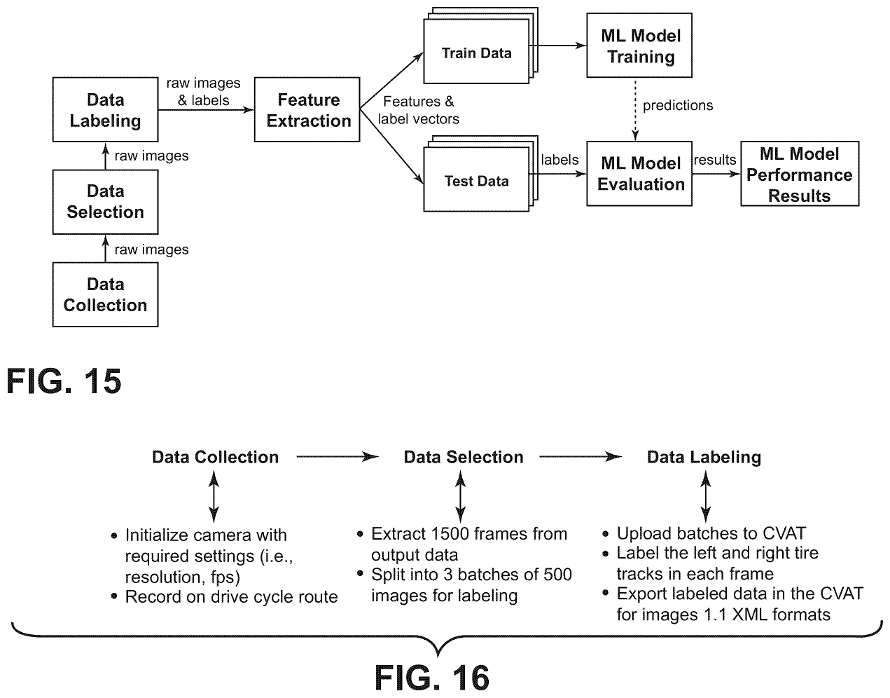

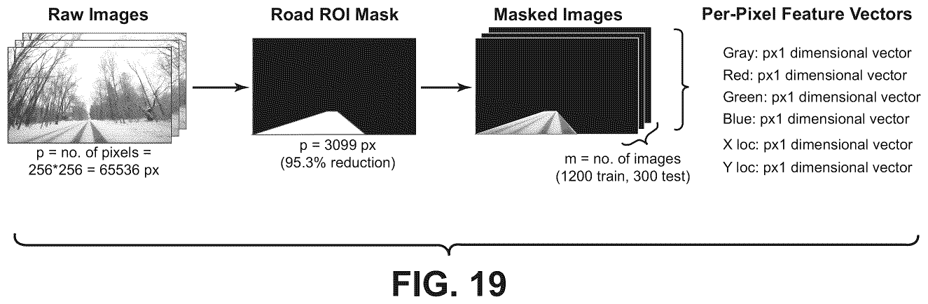

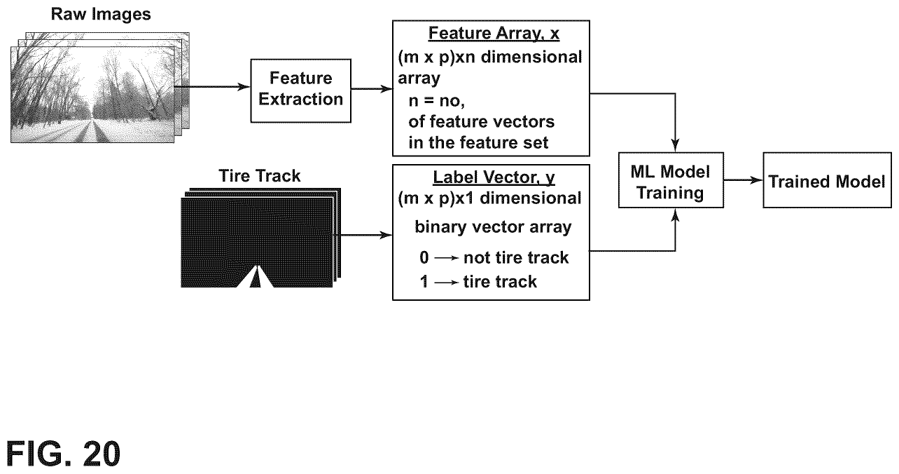

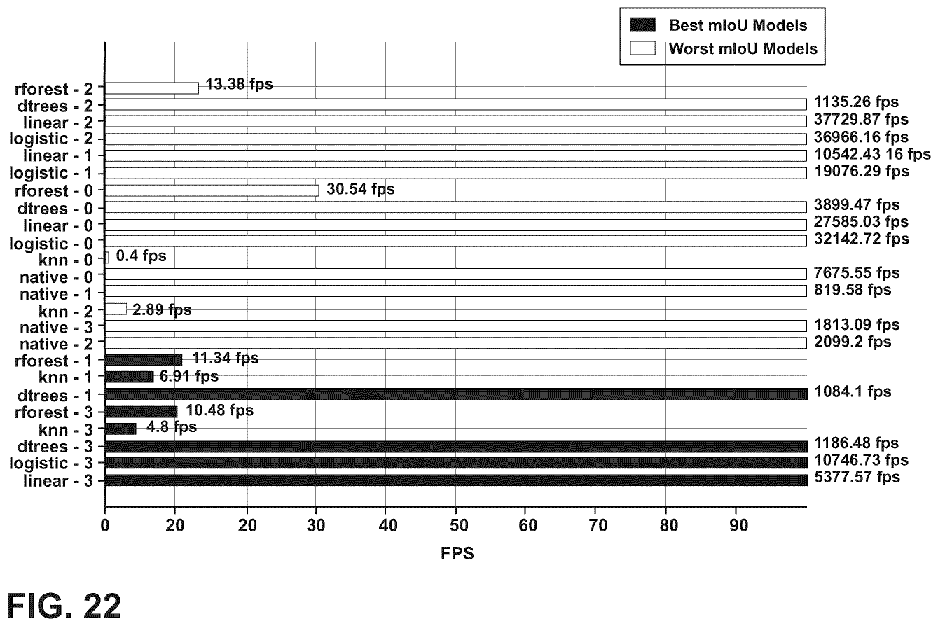

As discussed above in connection with FIG. 2, another aspect of the present disclosure is a tire track ID module (e.g. software). FIGS. 15-22 and the corresponding discussion describe various approaches that may be utilized to implement a Tire Track ID lane detection module. T-With reference to FIG. 15, a methodology for developing models for tire track identification my involve 7 main steps to get to a point at which the results can be analyzed for conclusiveness with regards to the best (most accurate) model and feature set for this task. The two main pipelines may comprise data preparation and model development. For data preparation, the tasks included collecting data, selecting data, and then labeling the data. Next, for model development, the tasks included extracting features from the data, training the models, evaluating the models, and then using the model results for analysis. Specific explanations concerning these tasks is described herein in connection with FIGS. 15-22.

Three main tasks were performed to fully prepare data for use in ML development and evaluation. FIG. 16 demonstrates these tasks and how they relate to one another to provide data that is suitable for modeling.

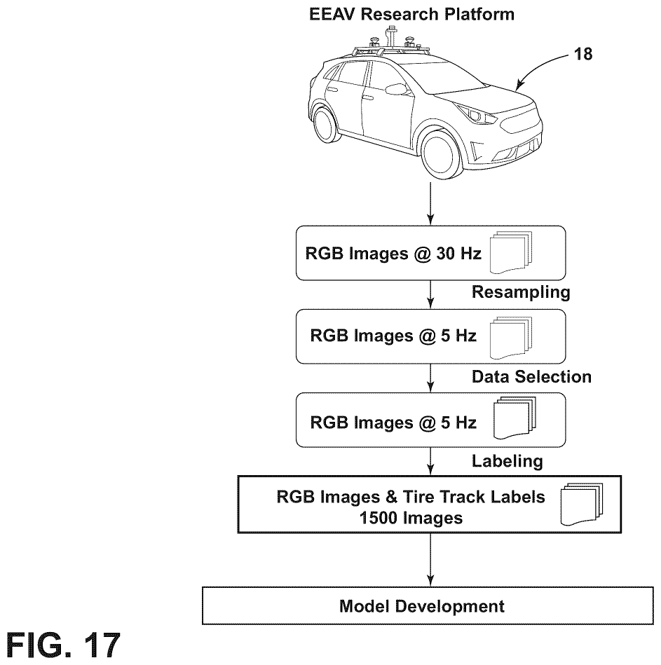

With reference to FIG. 17, data collection in accordance with an aspect of the present disclosure was accomplished using EEAVC vehicle 18 described above. As discussed above, this vehicle may include a forward-facing RGB camera, 360° LiDAR, forward-facing radar, vehicle CAN bus interference and GNSS antennas. However, the forward-facing RGB camera was the only sensor used for data collection in connection with FIGS. 15-22 of the present disclosure. The camera provided RGB images at a 120° field of view, a resolution of 720×1280 pixels, and a frame rate of 30 FPS.

The recorded data was then resampled from 30 FPS to 5 FPS to lessen the number of images. Next, a total of 1500 images were selected for use based on the presence of visible tire tracks. These 1500 images were separated into 3 batches, each containing 500 images which allowed for streamlining the labeling process.

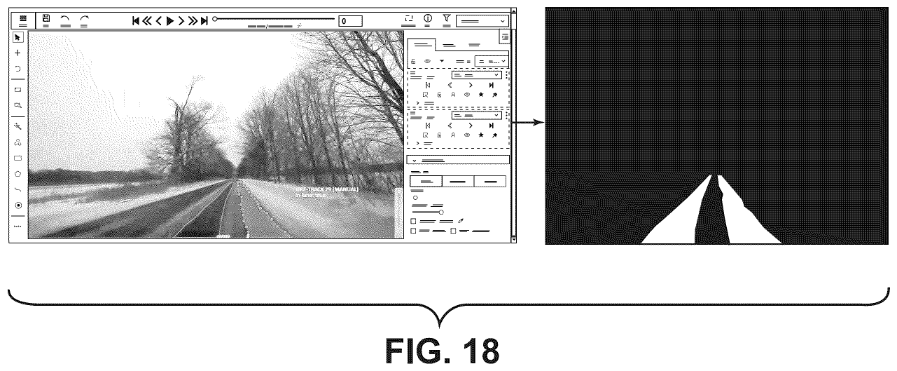

The program used to annotate the images may comprise an open-sourced, web-based Computer Vision Annotation Tool (CVAT) software. CVAT allows annotations for image classification, image segmentation, and object detection. The images may be uploaded to CVAT in batches (as organized in the data selection process). These batches may then be scanned image-by-image for annotating. An overall approach may be to annotate each image for the left and right tire tracks within a lane using polygon segmentation. These annotations may be used to create a mask of the tire tracks which may be used as pixel-level labels of either being a tire track or not a tire track, shown as white or black, respectively, in FIG. 18.

CVAT uses a custom XML format for storing pixel segmentation labels called “Images for CVAT 1.1”. These XML files may contain the attributes such as the position of pixels and assigned tags (tire-track, road, road edge boundary) for the labels used in the model development.

Prior to feature extraction, the images may be masked with a region of interest that includes the entirety of the drivable space. Methods for drivable space detection are known and/or being developed. Additional known approaches using more than just a camera may be based on ground-penetrating radar or LiDAR. The drivable region detections of these examples are represented herein by implementing a static Region of Interest (ROI) in which all pixels within the ROI are the drivable space and the pixels outside the ROI are the background. This may be implemented by creating an ROI mask and only using the pixels within the ROI as input to the model. The features extracted from the images may comprise the raw red, green, blue, grayscale pixel values, and the pixel x, y locations, i.e. X loc and Y loc.

These six different feature vectors may then be grouped into four separate feature sets that represent the final input to the model. This may be done to identify combinations of the most important features that yield the highest performance (most accurate) results (or acceptable results). With resizing of the images from 720×1280 px to 256×256 px, these feature arrays were not large enough to require batching of the images. The entire model may be trained with the singular input array X having the shape of X_shape=((m*p), n). Where m is the total number of images, p is the total number of pixels of the ROI per image (3099 pixels for 256×256 dimensions), and n is the number of feature vectors in the array. These values are tabulated in Table 8 to show the total size of inputs that may be utilized for both training and testing.

TABLE 8
included feature sets used in model development
along with their array shapes.

| | Included | Train Array | Test Array |
|---|---|---|---|
| Feature | Feature | Shape | Shape |
| Set | Vector | (m = 1200) | (m = 300) |
| 0 | Gray | (3718800, 1) | (929700, 1) |
| 1 | Gray, X loc, Y loc | (3718800, 3) | (929700, 3) |
| 2 | Red, Green, Blue | (3718800, 3) | (929700, 3) |
| 3 | Red, Green, Blue, | (3718800, 5) | (929700, 5) |
| | X loc, Y loc | | |

The input feature array X and label vector y may be extracted from the images and labels coming from the feature extraction block of the pipeline. These inputs may then be fed into the ML model for training. According to an aspect of the present disclosure, six different models may be trained to use for analysis to determine the model with the greatest performance (accuracy) metrics. The models evaluated in connection with the present disclosure include K-Nearest Neighbor (KNN), Naive-Bayes, Decision Trees, Random Forest, Linear Regression, Logistic Regression, and Support Vector Machines (SVM). Although SVM was initially selected for inclusion, it was not ultimately included because the training time for this method was extremely high (˜1 minute per image) due to the high dimensionality of the input array X. After this evaluation, the models used for training were KNN, Naive-Bayes, Decision Trees, Random Forest, Linear Regression, and Logistic Regression due to the capabilities of computing binary classification.

The predicted outputs of the model y_{pred} may be compared with the ground truth y for evaluation. The metrics may be evaluated based on the ability to draw significant conclusions concerning the performance of each model. These metrics may comprise the mean intersection of union (mIoU), pixel prediction accuracy, precision, recall, F1 score, and frames per second (FPS). The equations below demonstrate these calculations, as well as the four corners of the confusion matrix indicating the definitions of true positives, false negatives, true negatives, and false negatives.
True Positive (TP): no. of pixels classified correctly as in a tire track
False Positive (FP): no. of pixels classified incorrectly as in a tire track
True Negative (TN): no. of pixels classified correctly as not in a tire track
False Negative (FN): no. of pixels classified incorrectly as not in a tire track

$$\begin{matrix}Accuracy = \frac{TP + TN}{TP + TN + FP + FN} & ( 4 ) \\ mIoU = 1 / n * {\sum }_{i = 1}^{n} \frac{{TP}_{i}}{{TP}_{i} + {FP}_{i} + {FN}_{i}} , where n = \# of classes & ( 5 ) \\ Precision = \frac{TP}{TP + FP} & ( 6 ) \\ Recall = \frac{TP}{TP + FN} & ( 7 ) \\ F 1 Score = 2 * \frac{precision * recall}{precision + recall} & ( 8 )\end{matrix}$$

The overall results of the models are shown in Table 9.

TABLE 9
Resulting mIoU, accuracy, FPS, precision, recall, and F1 score
for all models, indicating the performance of the tire tracks.

| | Feature | | Accu- | | Preci- | | F1 |
|---|---|---|---|---|---|---|---|
| Method | Set | mIoU | racy | FPS | sion | Recall | Score |
| Knn | 0 | 0.742 | 0.8314 | 0.4 | 0.803 | 0.9078 | 0.852 |
| Knn | 1 | 0.832 | 0.9007 | 6.9 | 0.896 | 0.9215 | 0.908 |
| Knn | 2 | 0.738 | 0.8341 | 2.9 | 0.828 | 0.8713 | 0.849 |
| Knn | 3 | 0.831 | 0.9002 | 4.8 | 0.899 | 0.9164 | 0.908 |
| naive | 0 | 0.741 | 0.8203 | 7675.5 | 0.763 | 0.9624 | 0.851 |
| naive | 1 | 0.740 | 0.8191 | 819.6 | 0.762 | 0.9628 | 0.851 |
| naive | 2 | 0.732 | 0.8102 | 2099.2 | 0.750 | 0.9677 | 0.845 |
| naive | 3 | 0.733 | 0.8112 | 1813.1 | 0.751 | 0.9674 | 0.846 |
| rforest | 0 | 0.757 | 0.8367 | 30.5 | 0.788 | 0.9510 | 0.862 |
| rforest | 1 | 0.834 | 0.9023 | 11.3 | 0.899 | 0.9205 | 0.910 |
| rforest | 2 | 0.771 | 0.8578 | 13.4 | 0.848 | 0.8942 | 0.871 |
| rforest | 3 | 0.831 | 0.9003 | 10.5 | 0.899 | 0.9162 | 0.908 |
| dtrees | 0 | 0.757 | 0.8367 | 3899.5 | 0.788 | 0.9510 | 0.862 |
| dtrees | 1 | 0.832 | 0.9017 | 1084.1 | 0.905 | 0.9117 | 0.908 |
| dtrees | 2 | 0.771 | 0.8579 | 1335.3 | 0.849 | 0.8934 | 0.871 |
| dtrees | 3 | 0.801 | 0.8806 | 1186.5 | 0.882 | 0.8968 | 0.889 |
| logistic | 0 | 0.752 | 0.8313 | 32142.7 | 0.779 | 0.9551 | 0.858 |
| logistic | 1 | 0.765 | 0.8410 | 19076.3 | 0.785 | 0.9683 | 0.867 |

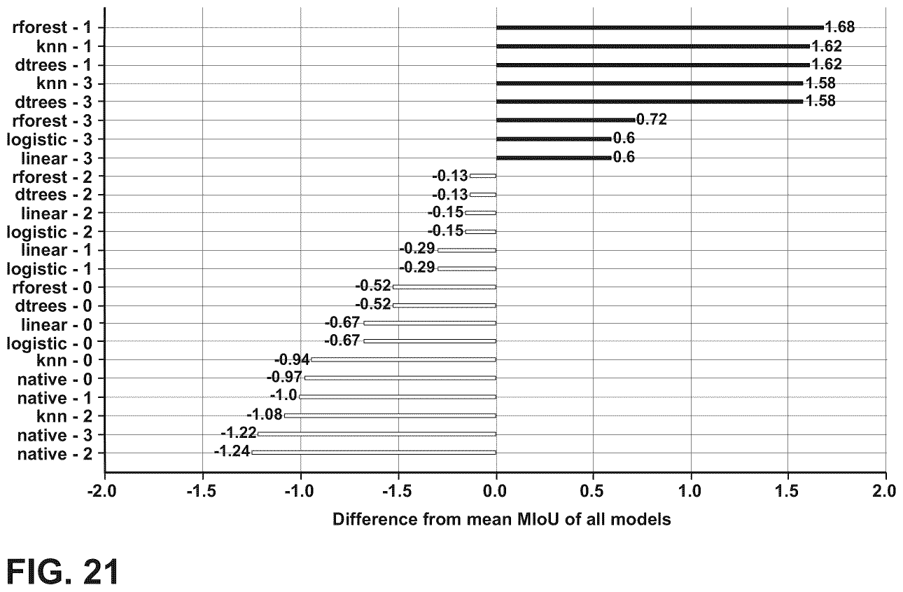

The average accuracy and mIoU of all models are 85.3% and 77.5%, respectively. This indicates that the methodology of the data preparation was successful with regards to identifying tire tracks, as this is the average of all models and the feature sets are using raw camera data, not neural networks for feature extraction which may improve these results. To identify the model with the greatest mIoU, each model was compared to the mean of all model's mIoU values. The best performing model and feature set pair were the random forest model and feature set 1, containing grayscale pixel values and the pixel X, Y locations. In general, models using a feature set containing the pixel locations tend to outperform models without pixel locations. A possible explanation is that the tire track locations are very consistent throughout the drive cycles since the tire tracks were located within the lane of the vehicle. Additionally, with reference to FIG. 21, grayscale may provide higher accuracy. Specifically, the top 3 performing models in this evaluation all use grayscale. With regards to the type of model to use, Random Forest is the best performing model for every single feature set input.

However, with regards to the performance of the model's frame rate, the Random Forest models tend to be slower. The best model with regards to high mIoU with a high frame rate is Decision Trees with the feature set 1. The Decision Tree model performs almost as well as the Random Forest Model. However, the frame rate of the Decision Tree Model is 95.94 times faster than the Random Forest Model with the same feature set input.

Improved autonomous vehicle functionalities beyond L2 ADAS features may include adverse weather conditions within the ODD. The present disclosure expands the ODD in snowy road conditions by utilizing a feature on the road's surface which is commonly extracted by human drivers. The present disclosure includes a methodology for a data preparation pipeline by recording data on the EEAV research platform and labeling the data using the Computer Vision Annotation Tool (CVAT). The present disclosure demonstrates how this data may be used in model development, compares 6 different machine learning methods (i.e. Decision Trees, Random Forest, K-Nearest Neighbor, Logistic Regression, Linear Regression, and Naive-Bayes) trained with 4 different feature sets consisting of a variety of grayscale & RGB values and including (and excluding) pixel locations. The results from this comparison showed that the Random Forest classifier (Model) had the highest mIoU. However, due to the low frame rate of 11.3 FPS of the Random Forest Model, the Decision Trees classifier (Model) may be the preferred model for current vehicles. The Decision Trees Model may be trained using grayscale pixel values and the pixel X and Y locations. This model resulted in a mIoU of 83.2%, accuracy of 90.2%, a frame rate of 1084.1 FPS, a precision of 90.5%, recall of 91.2%, and an F1 score of 90.8%.

Higher resulting metrics may be achieved by scaling data collection to include a larger dataset, implementing new feature extraction methods to include post-processed features and/or leverage neural networks. Including more diverse data may be utilized to further verify the capabilities of models. A model according to the present disclosure may be included in a hierarchical system that may include methods (capability) for perception in snowy weather conditions as well as clear weather conditions.

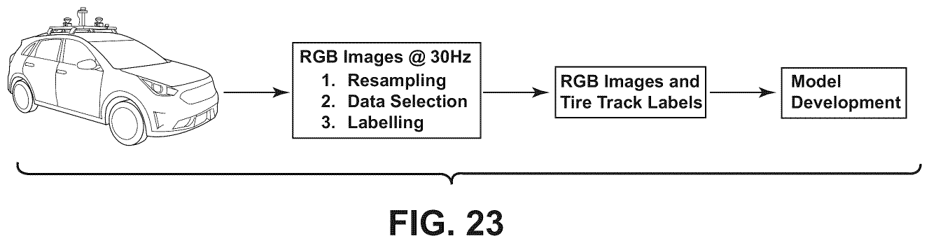

As discussed below in connection with FIGS. 23-30, another aspect of the present disclosure involves utilizing a computationally light, cost-effective, and high-accuracy method of extracting driveable region information. This may, optionally, be accomplished using a single camera which may comprise an existing automotive sensor. ML techniques such as Conventional Neural Network (CNN) may be utilized in computer vision algorithms and applications and in segmentation research. As discussed above in connection with detecting tire tracks in snowy weather conditions, an ML model may involve image pre-processing and feature engineering. This is addressed herein in connection with FIGS. 23-30 by using a CNN. As discussed below, both supervised ML semantic segmentation models and CNNs were developed. These methods were then compared for detecting tire tracks in the snow. The following topics are discussed in more detail below:
1) Custom data acquisition method for tire track data collection and labeling
2) Snow tire track image preprocessing and feature extraction
3) Tire track identification CNN architecture
4) CNN and ML model performance comparison for snow tire track identification

This section first discusses methods that may be used to collect and prepare data. The data that has been processed may then be used to develop models. The route consisted of two-lane arterial roads in Kalamazoo, Michigan that had road characteristics of interest. The drive cycle generally replicated roads that are rarely cleaned after snowfall and are maintained much less frequently than highways and other multi-lane roads. The data utilized herein was collected during the 2020 winter season. The lanes had snow occlusion with distinct tire track patterns, with the tire tracks visible to show the tarmac below and the lane line markings covered in snow.

With reference to FIG. 23, data was collected using EEAV vehicle 18. The sensor for the present disclosure comprises a forward-facing ZED 2 RGB stereo camera made by Steroelabs (“26” above). This camera has a 120-degree field of view wide-angle lens that captures images and videos using stereo vision. However, only one of the lenses was used for the study described herein in connection with FIGS. 23-30. The camera was set to record video at a frame rate of 29 frames per second with a resolution of 1280×720 pixels.

The camera was connected to the in-vehicle computer and data was collected as *.mp4 files over arterial roads with visible tire tracks and occluded lane lines. From these video files, a total of 1,500 individual frames were extracted for ML training. FIG. 23 shows an overview of this data collection process. The 1500 frames of images were divided into three batches, each with 500 images. Different parameters such as exposure, resolution, and occlusion were assessed in the images. Clear tire tracks with distinct tarmac and snow boundaries were chosen from the images.

The images that were previously segregated into different batches of frames may then be used for labeling. Every frame's tire tracks may be labeled “by hand” using an open-source, online tool (e.g. Computer Vision Annotation Tool (CVAT)). Images may be uploaded in batches and the labeled dataset of each batch may be exported with their corresponding raw images using the format: CVAT for images 1.1. This process may be repeated for all of the batches.

Each exported dataset contained the raw images and an Extensive Markup Language (XML) file which contained the attributes for the labels, such as the position of the tire-track with their corresponding pixel location on the image, image file name, and their assigned tags (tire-track, road, road-edge boundary). This process may be updated and more labels can be added if required for a particular application. The exported labels may then be further assessed for post-processing and training the ML and CNN models. An example of a data preparation pipeline is described in the next section.

To develop the ML model, the data may be preprocessed, and feature extraction may then be performed. The process of converting raw data into numerical features that the model can process while preserving information from the original data set may be referred to as feature extraction. This may be done because it may produce significantly better results compared to applying machine learning to the raw dataset directly.

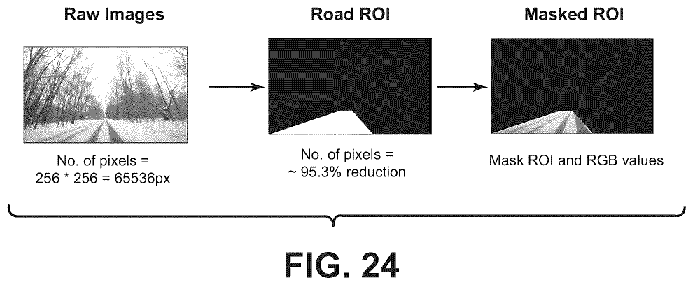

To improve feature detection and reduce the computational cost, images may be masked with a Region of Interest (ROI) that includes just the road surface, not the entire frame. As stated in prior publications, it is seen that different methods may be used to detect road surfaces with high accuracy with an array of sensors. These road surface detections were implemented according to an aspect of the present disclosure by using a static ROI in which the pixels inside the ROI are the road surface, and every other pixel outside the ROI is considered to be the background. FIG. 24 shows a process to extract the masked images for the ROI.

The raw images may be resized to a desired shape from an original size (e.g. 1280×720 pixels). For example, the images may be chosen to be 256×256 pixels. The road ROI mask may be obtained from a raw image to reduce the number of pixels used for training, and to reduce the computational cost.

The Road ROI may consist of 3099 pixels, which may be only about 5% of the total pixels in a raw image. The ROI mask may then be fused with a raw image to obtain all of the pixels within the ROI. This may then be the input to the model. The different features extracted from the masked images include the red, green, blue, grayscale pixel values, and the pixel X, Y locations.

The different feature vectors shown in Table 10 are grouped into different sets and are individually selected to be the final input to the model.

TABLE 10
Feature Set Properties

| | Included | Train Array | Test Array |
|---|---|---|---|
| Feature | Feature | Shape | Shape |
| set | Vector | (m = 1200) | (m = 300) |
| 0 | Gray | (3718800, 1) | (929700, 1) |
| 1 | Gray X loc, Y loc | (3718800, 1) | (929700, 1) |
| 2 | Red, Green, Blue | (3718800, 3) | (929700, 3) |
| 3 | Red, Green, Blue, | (3718800, 5) | (929700, 5) |
| | X loc, Y loc | | |

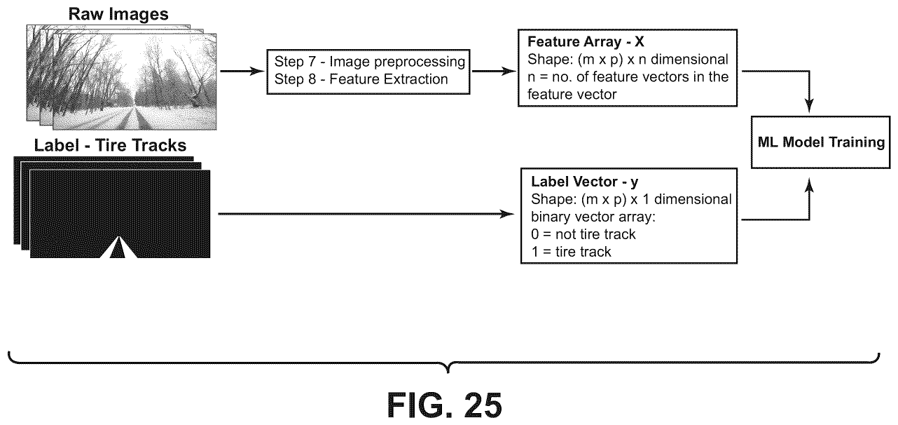

The results show the features that contribute the most to the model and yield the highest performance. The model may be split into a 55-45% train test split. The entire model may be trained using a single input array X having the shape=((m*p),n) where m is the total number of images, p is the number of pixels in the ROI of each image (3099 pixels for the 256×256 sized images), and n is the number of feature vectors in the array. An overview of this process is shown in FIG. 25.

As discussed above, various ML models may be trained from the input features and their respective labels. The input feature array X and label vector y may be extracted from the image preprocessing and feature extraction block, and then fed as inputs to the ML model. Six different models were evaluated to determine the feature set/model combination for the highest performance metrics. Models that were evaluated include K—Nearest Neighbor (KNN), Naive-Bayes, Decision Trees (Dtrees), Random Forest, Linear Regression, and Logistic Regression. These models were chosen for their characteristics and capabilities in commuting binary classification.

The outputs from the predicted model y_{pred} were compared with ground truth for evaluation. The metrics used for evaluation were the intersection over union (IoU), mIoU, pixel prediction accuracy, precision, recall, F1 score, and frame per second (FPS). These metrics were evaluated based on the ability to draw strong conclusions from the model's performance. Below are the equations demonstrating these calculations as well as the four corners of a confusion matrix, which define the true positives, true negatives, false positives, and false negatives.
True Positive (TP): no. of pixels classified correctly as in a tire track
False Positive (FP): no. of pixels classified incorrectly as in a tire track
True Negative (TN): no. of pixels classified correctly as not in a tire track
False Negative (FN): no. of pixels classified incorrectly as not in a tire track

$$\begin{matrix}Accuracy = \frac{total correct predictions}{all predictions} = \frac{TP + TN}{TP + TN + FP + FN} & ( 9 ) \\ IoU ( Jaccard Index ) = \frac{\vert A ⋂ B \vert}{\vert A ⋃ B \vert} = \frac{\vert A ⋂ B \vert}{\vert A \vert + \vert B \vert - \vert A ⋂ B \vert} & ( 10 )\end{matrix}$$

$$mIoU = 1 / n * {\sum }_{i = 1}^{n} \frac{intersection}{union} = 1 / n * {\sum }_{i = 1}^{n} \frac{{TP}_{i}}{{TP}_{i} + {FP}_{i} + {FN}_{i}} , where n = \# of classes \qquad ( 11 )$$

$$\begin{matrix}Precision = \frac{TP}{TP + FP} & ( 12 ) \\ Recall = \frac{TP}{TP + FN} & ( 13 ) \\ F 1 Score = 2 * \frac{precision * recall}{precision + recall} & ( 14 )\end{matrix}$$

Following the creation of the ML models, it was discovered that this method, in this instance, may involve a significant amount of feature engineering or image pre-processing. The raw images may be cropped and turned to grayscale. Similarly, the segmentation masks may be cropped to generate the ROI mask, and the X and Y pixel locations from the segmentation masks may be saved to feed into the model, as explained in the image pre-processing and feature extraction sections below. Furthermore, the ROI is static, which means it is fixed for each image and does not account for changing road curvature. Overall, this process may involve a substantial level of effort, which may be addressed using CNN.

Deep learning may perform significantly better on a wide range of tasks, including image recognition, natural language processing, and speech recognition. Deep networks, when compared to traditional ML algorithms, may scale effectively with data, may not require feature engineering, may be adaptable and transferable, and may perform better on larger datasets with unbalanced classes.

CNNs are a type of deep neural network whose architecture may be designed to automatically conduct feature extraction, thus eliminating this step. CNNs may be configured to create feature maps by performing convolutions to the input layers, which may then be passed to the next layer. In contrast to basic ML techniques, CNNs can extract useful features from raw data, eliminating (or reducing) the need for manual image processing. As noted above, the ML model of the present disclosure involved feature engineering, and it did not function as an end-to-end pipeline for tire track identification. A CNN may be utilized to make this process easier and to improve the overall accuracy.

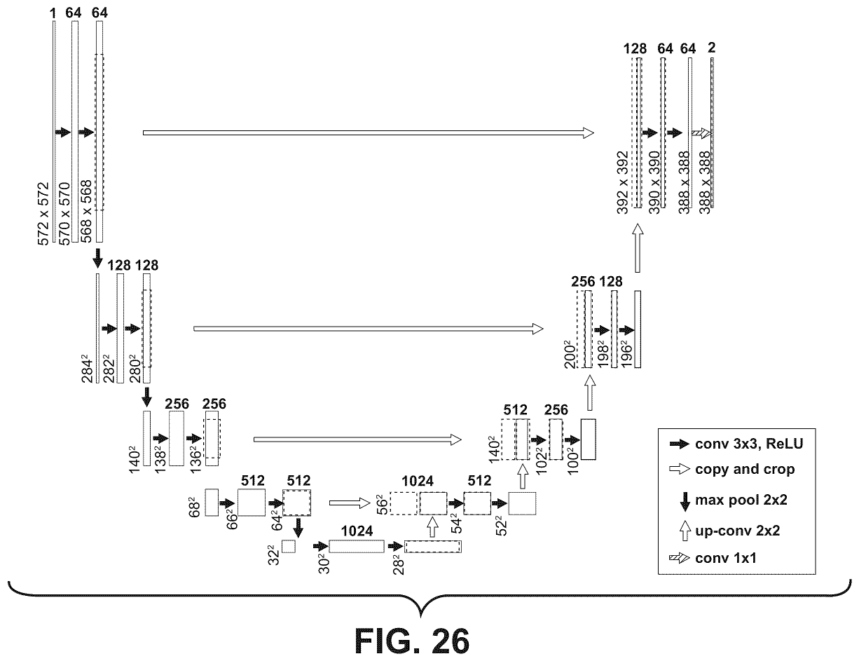

The U-net architecture has demonstrated excellent performance in computer vision segmentation. CNN's basic premise is to learn an image's feature mapping and use it to create more sophisticated feature maps. This may work well in classification problems since the image is turned into a vector, which is then classified. In image segmentation, however, a feature map may be transformed into a vector, and an image may be reconstructed from this vector. With reference to FIG. 26, U-net architecture was developed specifically for this problem, and it has been utilized in a medical application.

The U-net architecture may be configured to learn the image's feature maps while converting it to a vector, and the same mapping may be used to convert it back to an image. The left side of the U-net architecture (FIG. 26) is known as the contracting path, while the right side is known as the expansive path. The number of feature channels/filters doubles after each downsampling block to learn more complicated structures from the previous layer's output, while the image size decreases. This path may comprise numerous contraction blocks. Each block takes an input and applies it to a 3×3 convolutional layer with a rectified linear unit (ReLU) activation function. The padding is set to ‘same’ which is followed by a 2×2 max-pooling layer blocks. Each block takes an input and applies it to a convolutional layer with a rectified linear unit for downsampling.

It may start with 32 feature channels and double them with every contraction block until there are 512 feature channels, then move onto the expansive path. Each block in the one 2×2 up-sampling or up-convolution layer with a ReLU activation function and padding may be set to ‘same’. The input may be appended by the feature maps of the matching contraction layer with each block in the up-convolution, which is known as concatenating and is indicated by the arrow between the two layers in FIG. 26. The number of feature channels is halved with each block in this layer. A 1×1 convolution layer is applied in the final layer, with the number of feature maps equaling the number of required classes/segments. In addition, in both the expansive and contraction paths, a dropout layer is added between each convolution layer. This reduces model overfitting by randomly shutting down the necessary number of neurons in that layer.

As mentioned above, different metrics may be used to evaluate a model's performance. From equation (9) above, the accuracy is the fraction of predictions a model got right. However, accuracy alone does not provide a complete measure with regards to class-imbalanced datasets. In the dataset described herein, there is significant imbalance between the tire tracks and the background. Thus, accuracy (by itself) may not be a suitable metric for evaluation. In particular, the inaccuracy of minority classes may be overshadowed by the accuracy of the majority classes when compared to pixel-wise accuracy. IoU, which is also known as Jaccard Index (equation 15), may be substantially more suggestive of success for segmentation tasks in some cases, (e.g. when the input data is sparse).

$$Jaccard Index ( IoU ) = \frac{\vert T ⋂ P \vert ( Area of Overlap )}{\vert T ⋃ P \vert ( Area of Union )} \qquad ( 15 )$$

When training labels contain 80-90% background and only a tiny fraction of positive labels, a basic measure such as accuracy may score up to 80-90% by categorizing everything as background. Because IoU is unconcerned about true negatives, even with extremely sparse data, this naive solution (everything background) will not arise. IoU computes the overlapping region for the true and anticipated labels by comparing the similarity of finite sample sets A, B as the IoU. As stated in equation (15), T is the true label image and P is the prediction of the output image. This may be used as a metric, and it may provide a more accurate way of measuring IoU in a model's segmentation region.

One or more loss functions may be used in a model as described herein. Loss functions may be used to reduce loss and the number of incorrect predictions made. The loss function Binary Cross-Entropy (BCE) may be used in binary classification. The BCE function is:

BCE=−t₁log(s₁0−(1−t₁)log(1−s₁) (16)

where t₁ denotes the label/segmentation mask and s₁ denotes the labels predicted probability across all images. BCE may be preferable in some cases because the model predicts the segmentation mask of the tire track.

The Jaccard Loss, which is equal to the negative Jaccard Index from equation (15), is another suitable loss function. A higher IoU value indicates that there is more overlap between the true label and the predicted label. However, the loss function is concerned with minimizing IoU, which is why a negative Jaccard Index may be used as the loss function to reduce loss.

The model may be trained using input images and their associated segmentation masks. Google Colab Pro's cloud GPU may be used to train the model. The ML model's input feature vector array may be used with feature set 2 (RGB images). The shape of the training array may be m×n×p×l)=(1300, 256, 256, 3) where m is the number of images in the training set, n is the image height, p is the image width, and/is the number of channels in the image. The images may be resized to a desired size in feature extraction (6b.), and use feature set 2, which uses the image's RGB values. The raw RGB images may be used without any pre-processing because image pre-processing is not required.

Stochastic Gradient Descent (SGD) and Adaptive moment estimation (Adam) have been considered for optimizers. Optimizers update the model in response to the loss function's output, attempting to minimize the loss function's output. SGD begins with a random initial value and continues to take steps with a learning rate to converge to the minima. SGDs may be relatively simple to implement, and fast for problems with a large number of training examples. However, SGDs may have a disadvantage in that they may require extensive parameter tuning. Unlike Stochastic Gradient Descent, Adam is computationally efficient and it may be better suited to problems with noisy and/or sparse gradients because it computes adaptive learning rates. For image segmentation, Adam may provide a powerful loss function, which is why Adam may be utilized as an optimizer.

As discussed above, BCE and Jaccard loss are two different loss functions that may be used. The batch size may be set to 16 and the model may be run for 25 epochs with an early callback to save the model at the best epoch for the validation loss. For testing, training, and validation, the predicted images may be thresholded, and anything above 50% may be saved as a correct prediction. In an example according to an aspect of the present disclosure, there may be 7,760,097 trainable parameters in total.

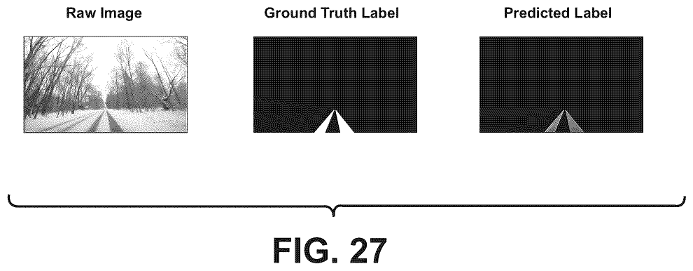

In contrast to the ML models described herein, the model's predicted output was an image. The predicted segmentation masks were then assessed using a variety of metrics. The model was tested for IoU, precision, recall, and F1 score, as discussed above. Equations (9-14) show how the confusion matrix may be used to perform these calculations. FIG. 27 shows the outputs from CNN.

When the model was run with the loss function set to BCE and Adam as the optimizer, the model's accuracy increases to ˜98%. However, as discussed above, accuracy may not be a good metric for datasets with significant class imbalance. Thus, the IoU was also tested.

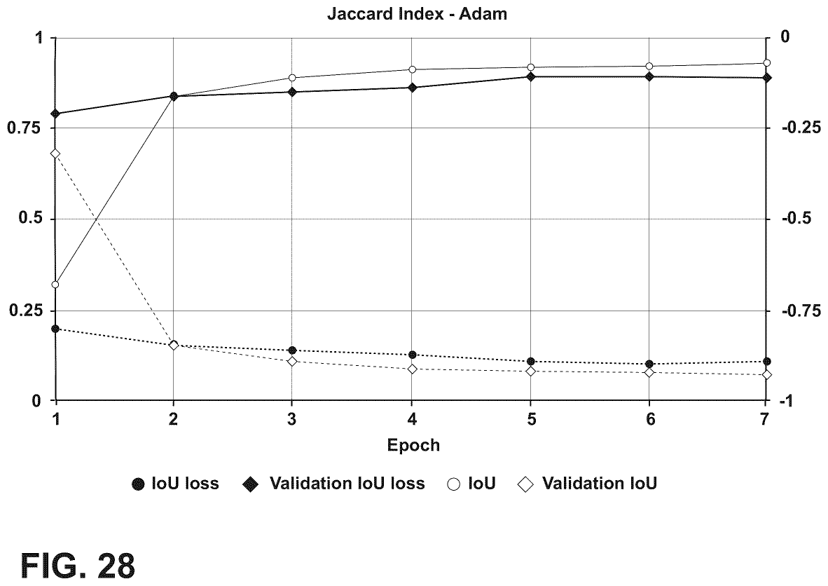

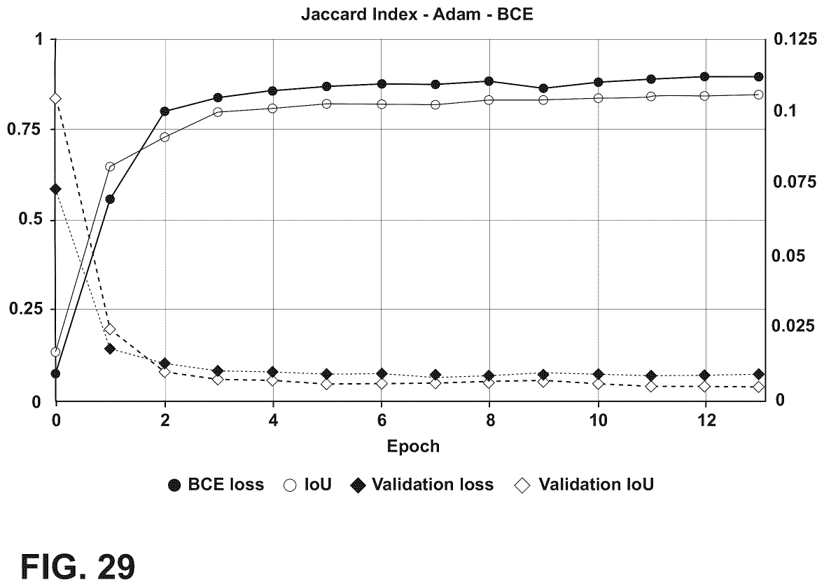

FIG. 28 shows that the model with Jaccard loss function has an IoU score of 93% and a validation IoU of 88%. FIG. 29 shows the IoU of the model with the loss function set to BCE is 89%, and the validation IoU is 84%. Thus, when compared to BCE, the Jaccard loss function does a better job of finding the intersection/overlapping region for the segmentation masks between the true and predicted. Even though this is true, BCE may still be acceptable because it is only 3% less accurate. The two models described herein have an average frame rate of nearly 350 FPS.

The results of the best CNN and ML models are summarized in Table 11 below. Dtress with feature set 1 was found to be the model with the best performance in the prior study discussed above. The metrics for that model were compared to the CNN model with feature set 2 since preprocessing is not required in this case.

TABLE 11
CNN and ML Metrics

| | Feature | Accu- | Preci- | | F1 | |
|---|---|---|---|---|---|---|
| Model | set | racy | sion | Recall | Score | FPS |
| CNN | 2 | 0.98 | 0.96 | 0.95 | 0.96 | 350.32 |
| Dtress | 1 | 0.90 | 0.905 | 0.911 | 0.908 | 1084.1 |

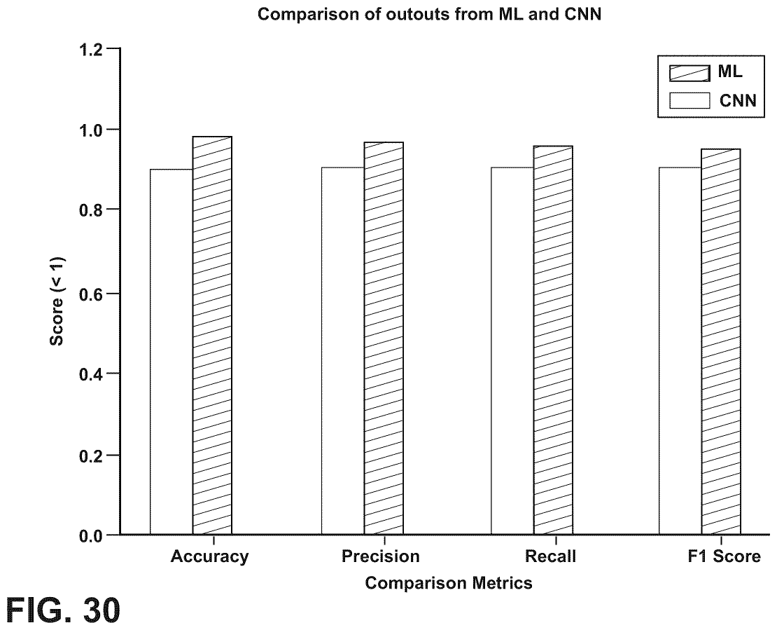

In general, with reference to FIG. 30, the CNN model performs better that the ML model without any image preprocessing on metrics like accuracy, precision, recall, and F1 score.

Limitations of the study discussed in connection with FIGS. 23-30 include comparing metrics such as mIoU with the previous ML models. The ML model with Dtress and feature set 1 obtains a mIoU of 83%, whereas the CNN achieves a mIoU of 65%. This may seem to imply that the ML model is more accurate at predicting tire tracks, but this does not take into account the use of an ROI. A static ROI for the ML model was employed, which means that the ML model only receives a portion of the raw image and the segmentation masks. The mIoU calculates the IoU for each class before averaging the results across all of them. Because only a section of the image is input into the ML model rather than the complete image, it performs better at detecting these tire tracks only in that precise region, which implies the model may not do well if the road geometry shifts or if the model is tested on the entire image.

The CNN, on the other hand, does not require a ROI but instead takes in the full image as input, lowering the mIoU because it is no longer simply looking at the ROI but the complete image. Another explanation for CNN's lower mIoU is the significant class imbalance (more background pixels and fewer tire track pixels), as well as the fact that deep neural networks require more training data than ML models which means to improve the mIoU we will need to train the model on larger datasets. Another way to attain a higher mIoU may be to crop the ROI for images and segmentation masks in substantially the same way as the ML models described herein, and then use that as the input to the CNN. However, this may require preprocessing and feature engineering, which is a potential drawback associated with the ML models addressed herein.

An aspect of the present disclosure is a method for extracting a drivable region for snowy road conditions when the lane lines are occluded. This may include focusing on identifying tire tracks. Data may be collected on an instrumented vehicle, and the data may be processed by extracting frames from the videos, segmenting them into batches, and labeling them (e.g. using CVAT). The present disclosure describes how this information may be used in a model development process. Using just the raw image, and no image pre-processing or feature extraction, a U-net-based CNN was evaluated for IoU, Accuracy, Feature set, Recall, F1 score, and FPS. As discussed above, the IoU score for the model with the Jaccard loss function was 93%. The model had an accuracy of 98%, a 95% recall, a 96% precision, and a 96% F1 score. Furthermore, a significant improvement in these metrics was found when compared to the ML model described herein. By inputting the raw image and obtaining the predicted tire tracks, the present disclosure may provide a full end-to-end solution for detecting drivable regions in snowy road conditions.

The present disclosure further demonstrates that drivable region detection in inclement weather is feasible using existing technology in a single camera. The process may be improved by improving image processing and tuning the CNN.

Another aspect of the present disclosure is a hierarchical system that properly assigns the most accurate model depending on the condition. This aspect of the disclosure comprises a system that may be configured for an automated vehicle software stack. Utilizing weather metrics, it is possible to determine which perception model outputs the most accurate results for a specific road condition as the vehicle encounters the road condition. An environmental observer (e.g. software) assigns a confidence value for which the model gives the greatest level of confidence in demonstrating the environment's drivable region or objects. This confidence value then signifies which perception model or algorithm should be used for the current road conditions.

Another aspect of the present disclosure involves collecting sensor data from a vehicle which includes, but is not limited to, Mobileye camera detections, stereo camera frames, LiDAR point clouds, GPS data, and vehicle CAN (Controller Area Network) data. This data may be stored as a Robotic Operating System's data storage method of Rosbags. The data from each sensor may then be extracted from the Rosbags and stored to an associated file (JSON for GPS, Mobileye, CAN: JPG for images; PCD for LiDAR). An ID is given to the drivecycle which the data was recorded during, in which, the weather data is extracted from RWiS (Road Weather information Systems) which is also stored with the drivecycles. All of the data may, optionally, be stored on a cloud platform and organized with SQL.

The present disclosure also includes robust algorithms for autonomous operations in any weather condition. The process may start with using multiple sensors to provide the sensor data to a computer of a vehicle. The computer then fuses the data using custom detection algorithms. The fused data allows the vehicle to plan the path in which the vehicle needs to go. The vehicle control algorithms seamlessly control the vehicle no matter what condition it is operating in.

It will be understood by one having ordinary skill in the art that construction of the described device and other components is not limited to any specific material. Other exemplary embodiments of the device disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the device as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present device. The exemplary structures and processes disclosed herein are for illustrative purposes and are not to be construed as limiting.

It is also to be understood that variations and modifications can be made on the aforementioned structures and methods without departing from the concepts of the present device, and further it is to be understood that such concepts are intended to be covered by the following claims unless these claims by their language expressly state otherwise.

The above description is considered that of the illustrated embodiments only. Modifications of the device will occur to those skilled in the art and to those who make or use the device. Therefore, it is understood that the embodiments shown in the drawings and described above are merely for illustrative purposes and not intended to limit the scope of the device, which is defined by the following claims as interpreted according to the principles of patent law, including the Doctrine of Equivalents.

What is claimed is:

1. A driver assistant system for vehicles, the driver assistance
system comprising: at least one sensor input feature that is
configured to receive sensor input data;
a snow coverage module that is configured to utilize sensor input data to determine snow coverage of a road in front of the vehicle;
a lane detection module that is configured to detect a lane of a road in front of the vehicle utilizing at least one of: 1) tire track identification (ID), 2) dynamic lane width, and 3) a map overlay;
a fusion module that is configured to fuse output from the lane detection module and output a lane line location equivalent to a vehicle planning subsystem.

2. The driver assistance system of claim 1, including:
a data storage utilizing subjective labeling for the snow coverage module.

3. The driver assistance system of claim 1, wherein:
the sensor input feature, the snow coverage module, the lane detection module, and the fusion module are configured to be implemented utilizing an on-board computer of a vehicle.

4. The driver assistance system of claim 3, wherein:
the system is configured to fuse the data utilizing detecting algorithms.

5. The driver assistance system of claim 4, wherein:
the fused data allows the vehicle to plan a path in which the vehicle needs to go.

6. The driver assistance system of claim 5, wherein:
the vehicle control algorithms are configured to seamlessly control the vehicle regardless of the operating conditions the vehicle is encountering.

7. The driver assistance system of claim 1, wherein:
the system comprises a hierarchical system that properly assigns the most accurate model depending on the condition.

8. The driver assistance system of claim 1, wherein:
the system is designed for an automated vehicle software stack.

9. The driver assistance system of claim 1, including:
an environment observer module that assigns a confidence value for which mode gives the greatest level of confidence in demonstrating the drivable region of the environment.

10. The driver assistance system of claim 9, wherein:
the confidence value signifies which perception model should be used during current conditions.

11. The driver assistance system of claim 1, wherein:
the sensor input data comprises at least one of camera images, LiDAR point clouds, GPS data, and vehicle Controller Area Network (CAN) data;
the sensor input data is stored as a Robotic Operation System's data storage method of Rosbags;
the data from each sensor is extracted from the Rosbags and stored in
an associated file; an ID is given to a drivecycle comprising data
recorded during, in which, weather data is extracted from a Road Weather information System, (RWiS), which is also stored with the drivecycles.
